(19) United States
(12) Patent Application Publication
(10) Pub. No.: US 2009/0270306 A1
(43) Pub. Date: Oct. 29, 2009

(54) Glass Storage

(76) Inventor: Paul Arthur Holmes, Cheshire (GB)

Correspondence Address: MARSHALL & MELHORN, LLC, FOUR SEAGATE - EIGHTH FLOOR, TOLEDO, OH, 43604, US

(21) Appl. No.: 12/086,104

(22) PCT Filed: Dec. 12, 2006
(86) PCT No.: PCT/GB2006/050447

§ 371 Date: Jun. 5, 2008

(30) Foreign Application Priority Data
Dec. 16, 2005 (GB) 0525566.6

(51) Int. Cl. C11D 3/00

(52) U.S. Cl. 510/528

(57) ABSTRACT

A stain inhibitor, which acts to neutralise alkali leached to the surface of a sheet of glass in the presence of water is disclosed. The stain inhibitor comprises a buffered, non-acidic compound, with a pKa value of between 6.0 and 10. Preferably, the non-acidic buffer compound is a mixture of boric acid and borax.

The present invention relates to the storage of glass, and in particular, to the protection of the surface of glass sheets during storage and transportation.

Sheets of glass are vulnerable to staining due to corrosion of the glass surface during storage, and also to damage caused by transit rub (where two sheets of glass rub together and/or where glass fragments from the cutting process rub the surface of the glass) during transportation. Both staining and transit rub result in the glass having a poor surface quality, which then creates problems in subsequent uses, for example, coating, printing, silvering, laminating, etc. The damage to the surface of the glass is often also visible to the eye. Known solutions to both staining and transit rub involve using an interleavant between adjacent sheets of glass. The interleavant prevents adjacent sheets of glass from being in contact, reducing or eliminating transit rub. Typical interleavants include paper, PMMA (polymethyl methacrylate) beads and coconut husk flour.

Storing glass in humid conditions causes water to adsorb onto the surface of the glass. Staining of the glass occurs when water on the surface of the glass sheet reacts with the silicate network of the glass. Water diffuses into the glass and exchanges for alkali glass components, which are then leached to the surface of the glass. The leached alkali glass components, particularly sodium and potassium, dissolve in the surface water to form an alkaline solution, which can attack and dissolve the silicate matrix of the glass itself, creating a series of etch pits on the surface of the glass. Other glass components, such as calcium and magnesium, can then react with the silicate species dissolved by the alkali attack to form insoluble salts, causing a precipitate to be deposited on the surface of the glass. The main approach to reduce staining of the glass surface is to use a chemical stain inhibitor, which reacts on the surface of the glass to neutralise the leached alkali. Other approaches, such as the use of film coatings on the surface of the glass may also be used. Chemical stain inhibitors are typically used in conjunction with interleavants, for example, coconut husk flour and PMMA beads, in order to prevent transit rub. Interleavants, such as paper, may also reduce the amount of staining present on the surface of the glass by absorbing some of the water present on the surface of the glass. As the amount of surface water is reduced, the amount of alkali leached and consequential surface damage to the glass are reduced.

GB 1,477,204 discloses the use of a weakly acidic material as a stain inhibitor. A porous support material, such as coconut shell flour or hardwood flour is used to support a weak acid, such as maleic or adipic acid. The porous support material is then mixed with particles of a chemically inert plastics material, such as a thermoplastic homopolymer or copolymer, to form an interleavant. The interleavant is then applied to the glass as a powder.

GB 1,413,031 also discloses the use of weak acids as stain inhibitors, for example, adipic acid, citric acid, maleic acid and malic acid, suspended in a solvent and sprayed onto the surface of the glass to be stored. U.S. Pat. No. 3,723,312 discloses the use of salicyclic acid, or a mixture of dedusted agglomerated salicyclic acid and an inert separator material, such as polystyrene beads, as a stain inhibitor.

US 2005/0011779 A1 discloses the use of watery mixtures of adipic and malic, adipic and citric or citric and malic acids as stain inhibitors for glass storage in conjunction with a separating powder as an interleavant. Groups of glass sheets are then hermetically sealed to prevent further water ingress during storage.

All of the above examples are concerned with the direct application of acids to the surface of the glass. However, the application of acids directly to the surface of the glass can actually cause the alkali leaching that produces staining of the glass to become worse.

Under acidic conditions, for example when adipic acid is used, onium ions (H₃O⁺ from the dissolution of the acid in the water present on the surface of the glass) diffuse into the glass and exchange for the alkali metal (sodium) present in the glass. This reaction releases sodium ions from the glass structure that then diffuse to the surface, and react with the acid stain inhibitor. As in the glass corrosion mechanism mentioned above, the alkaline solution of the sodium ions eventually neutralises all of the acid stain inhibitor and the pH on the surface of the glass then increases to initiate alkaline attack on the silicate network of the glass.

In the absence of the acid stain inhibitor, the diffusion of sodium ions to the surface of the glass would have occurred at a rate determined by the diffusion of any water present on the surface of the glass. This is because electrical neutrality must be preserved at the glass surface. Thus, any sodium ions diffusing to the surface must carry a counter-anion with them. In the absence of water, the only counter-anion available in the silicate network is the oxygen dianion, O²⁻, and this is immobile at temperatures below about 600° C. In the presence of acid stain inhibitors, however, the release of sodium from the network structure is simply an exchange of sodium ions for onium ions with no net change in charge and the counter-ion for the sodium and onium ions is the highly mobile hydroxyl anion, OH⁻. The direct application of an acid to the surface of the glass results in the mechanisms for sodium ion diffusion in the presence of surface water being catalysed, resulting in an alkaline attack on the silicate network of the glass. The direct application of an acid to the surface of the glass is therefore undesirable.

There is therefore a need for a stain inhibitor, which reduces the staining on the surface of the glass, and which does not act to promote leaching of the alkali content that leads to the dissolution of the silicate network of the glass.

The present invention addresses this problem by providing a stain inhibitor, which acts to neutralise alkali leached to the surface of a sheet of glass in the presence of water, comprising a buffer compound, which, before application to the glass, has a pKa value of between 6.0 and 10.0.

By using a buffer rather than an acid applied directly to the glass, any alkali leached to the surface of the glass can be neutralised without catalysis of the corrosion mechanism, as the concentration of onium ions on the surface of the glass is decreased in comparison to the acids used traditionally as stain inhibitors.

Preferably, the pKa value is between 7.0 and 9.2. More preferably, the pKa value is between 7.0 and 9.0. Preferably, the pH value of the buffer compound, when dissolved in DI water, is greater than 6.0. More preferably, the pH value of the buffer compound, when dissolved in DI water, is greater than 7.0. The buffer compound preferably has an anion which forms salts of calcium and magnesium that are soluble in water.

The buffer compound may comprise an inorganic acid or a non-acidic organic compound. The buffer compound may comprise a non-acidic organic compound. In this case, preferably, the buffer is one of tricine, triethanolamine hydrochloride, TRIS HCl, and TRIS succinate. The buffer compound may comprise an inorganic acid. In this case, preferably, the buffer compound may comprise a mixture of boric acid and a base, such that the initial pH of the mixture is greater than 6. Preferably, the pH is greater than 7.

The buffer compound may be applied to the surface of the glass as a powder. The powder may be first mixed with an interleavant, and then applied to the surface of the glass. Alternatively, the buffer compound may be applied to the surface of the glass in solution with a solvent. The solvent may be methanol. An interleavant may also be applied to the surface of the glass. The interleavant may be one of PMMA beads, UHMWPE beads, coconut husk flour, hard wood flour or paper.

The invention also provides a method of reducing the haze of the surface of a sheet of glass in storage, comprising applying a stain inhibitor to the surface of the glass, the stain inhibitor comprising a buffer compound, which, before application to the surface of the glass, has a pKa value between 6.0 and 10.

Glass treated with the stain inhibitor of the invention, and the use of a buffering, non-acidic compound as stain inhibitor to prevent the corrosion of glass in storage are also provided.

The invention will now be described by way of example only, and with reference to the accompanying drawings in which:

FIG. 1 is a graph illustrating the pH behaviour of a known stain inhibitor;

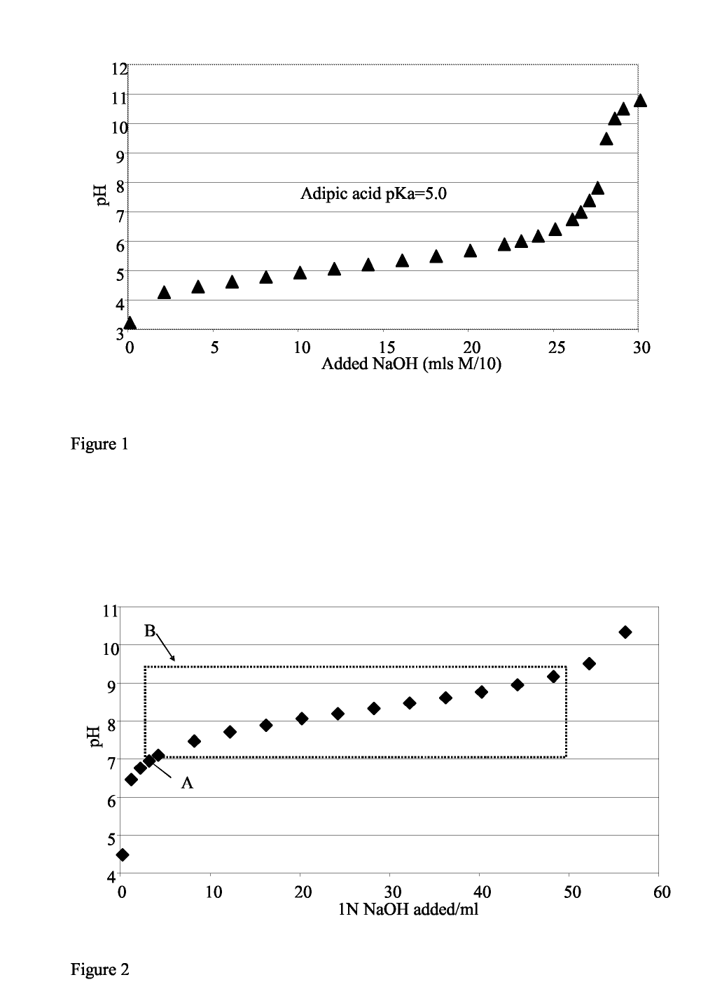

FIG. 2 is a graph illustrating the pH behaviour of TRIS (tris(hydroxymethyl) aminomethane and its salt with hydrochloric acid);

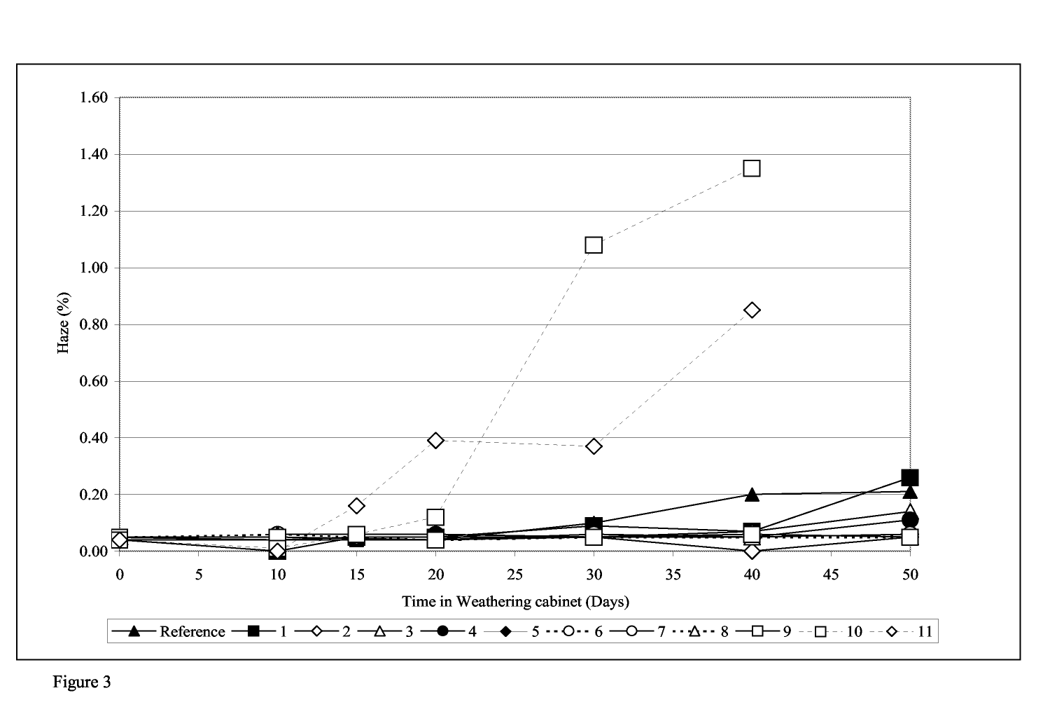

FIG. 3 is a graph showing the percentage haze for samples treated with various stain inhibitors and weathered for 50 days;

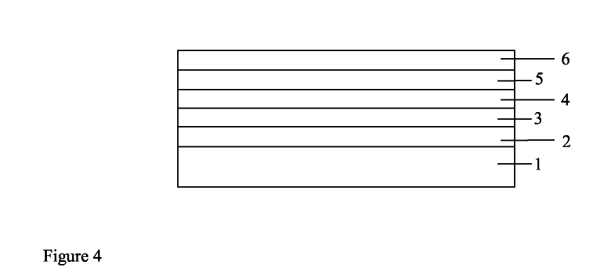

FIG. 4 is a schematic cross-section showing the multilayer coating stack used in resistance measurements; and

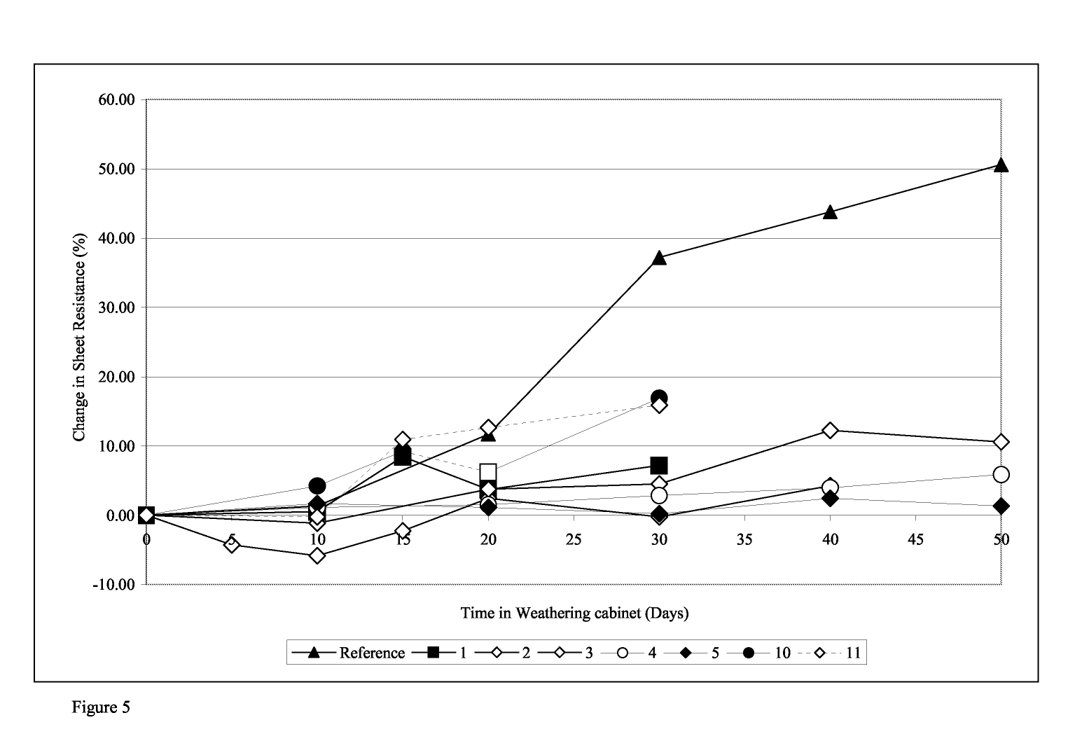

FIG. 5 is a graph showing the sheet resistance of coated samples treated with various stain inhibitors and weathered for 50 days.

The corrosion of silicate glass occurs when water from an adsorbed surface film diffuses into the silica network of the glass, and establishes an equilibrium:

≡Si—O—Si≡+H₂O⇄2≡Si—OH

The reaction is catalysed by the hydroxyl anion, and so is strongly pH dependent:

≡Si—O—Si≡+OH⁻⇄≡Si—OH+≡Si—O⁻

≡Si—O⁻+H₂O⇄≡Si—OH+OH⁻

Thus, the silicate network is stable under acid conditions, but is attacked rapidly at pH>9.4. However, under acid conditions, the onium ion, H₃O⁺ exchanges rapidly with the alkali in the glass:

≡Si—ONa+H₃O⁺⇄≡Si—OH+Na⁺H₂O

If the released alkali is not washed away, it will increase the pH of the water in contact with the glass surface, and as discussed above, if the pH exceeds 9.4, dissolution of the silicate network will commence. In addition, CO₂ dissolves in the adsorbed water film, creating carbonic acid, which also diffuses into the surface of the glass. At the same time as Na diffuses to the surface of the glass, the protons in the water are also exchanged for other elements, such as K, Ca, Mg. Ca and Mg precipitate at the surface of the glass when they react with dissolved carbonate and silicate anions to form insoluble salts (carbonates and silicates). Such insoluble salts are then re-deposited on the glass surface. The combination of precipitated salts and etched regions (from the dissolution of the silicate network) causes an increase in haze (decrease in direct light transmission of the glass). In addition, when alkali is leached to the surface of the glass, a region of the glass just below the surface becomes depleted of sodium. This can by verified by use of XPS (X-ray photon spectroscopy).

The corrosion process therefore starts with the diffusion of water and onium ions into the glass, resulting in leaching first of the alkali metals and then the alkaline earth metals. If the pH increases sufficiently, the actual silicate network will break down.

As discussed above, the use of adipic acid catalyses the first stage of the corrosion mechanism by increasing the onium ion concentration. The pKa value for the first ionisation of adipic acid is 4.4, and a 1% solution of adipic acid in water has a pH of 2.8, giving an increased concentration of onium ions compared with a glass surface where there is no acid present.

FIG. 1 illustrates how the behaviour of a conventional acid stain inhibitor, adipic acid, changes the pH of the adsorbed water layer at the glass surface during storage. FIG. 1 is a graph showing the change in pH of a solution of adipic acid (0.2 g in 200 ml water) against millilitres of added 0.1M sodium hydroxide to simulate the effect of sodium hydroxide leaching from the glass bulk to the surface. The adipic acid stain inhibitor remains very acidic (pH<5) during almost the entire addition of alkali and this will accelerate the sodium exchange in the region just below the surface of the glass. Eventually, all the acid is neutralised and further release of sodium hydroxide by diffusion to the glass surface causes a very rapid increase in pH to >9, which will initiate alkaline attack on the silicate network.

As an alternative to acids, one group of compounds that can be used to neutralise an alkali are neutral buffers. A buffer system is a mixture of two compounds: a weak acid HA, with its salt, Z⁺A⁻, where Z⁺ is an alkali metal, such as Na⁺, K⁺, or an alkali such as NH₄⁺; or a base, B, with its conjugate base, BH⁺X⁻, where X⁻ is an anion such as Cl⁻, CH₃COO⁻. A typical example is the phosphate buffer:

NaH₂PO₄+NaOH=Na₂HPO₄+H2O

In this case, A⁻ is (NaHPO₄)⁻. The pH of an equimolar mixture of the acid, HA, and the salt, NaA, is called the pKa and for the phosphate buffer above has a value of 7.2. Such pKa values are temperature dependent. A typical example of a buffer system using a conjugate base is a mixture of the organic base tris(hydroxymethyl) aminomethane and its salt with hydrochloric acid:

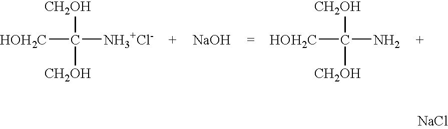

The above compound is normally referred to by the acronym TRIS, but may be known by the commercial name, Trizma. TRIS has a pKa value if 8.3.

Although in simple terms, the use of any neutral buffer solution should result in neutralisation of the alkali leached from the glass, there are four factors that must be taken into account when considering buffer solutions for use as stain inhibitors

### 1. Initial pH

As discussed above, the concentration of onium atoms resulting from the dissolution of an acid applied directly to the surface of the glass catalyses the leaching of alkali from the glass by encouraging the diffusion of sodium ions to the surface of the glass. This presents a problem when considering the use of neutral buffers as stain inhibitors, because the initial pH (the pH when dissolved in DI water) of the parent compound can be quite low. However, by adjusting the initial pH of the buffer solution, the concentration of onium ions can be reduced, lessening any chance of catalysis of the sodium ion diffusion. For example, a 0.2 wt % solution of pure sodium dihydrogen phosphate in DI water has a pH of 5.5. A pH of around 7 (that of DI water) reduces the onium ion concentration by over 10 times. This can be achieved by the addition of sodium hydroxide or disodium hydrogen phosphate. Similarly, the initial pH of a solution of 0.5M TRIS hydrochloride in DI water has a pH of 4.5, so a base must be added to the solution to raise the pH to approximately 7.

### 2. “Wasting” of Buffering Capability

The essential feature of a buffer is that the addition of significant quantities of either an acid or a base does not cause the pH of the equimolar mixture to change by more than 0.5. However, the purpose of a stain inhibitor is to neutralise the alkali leached from the surface of stored glass. Given that acid will not be leached from the stored glass under any circumstances, some of the buffering capacity of an equimolar buffer mixture would be wasted. Therefore, a more suitable initial pH for a buffer used as a stain inhibitor, when dissolved in DI water at concentrations of about 0.1M is at least 6, preferably 7. An initial pH of 6 reduces the onium ion concentration by 100 to 1000 times compared with adipic acid, a traditional stain inhibitor, which has a pH of 3-4.

### 3. Initiation of Alkaline Attack of Silicate Matrix

The alkaline attack of the silicate matrix of the glass described above begins when the pH of the solution on the surface of the glass reaches approximately 9. At this point, the surface of the glass begins to be etched away, and silicic acid is produced, which reacts with the Ca and Mg in the glass, causing the precipitation of insoluble silicates. In practice, a pH of 9.4, measured by washing the surface of ˜1000 cm² of glass with 100 mls of distilled water and determining the pH of the wash water using a pH electrode, is the maximum possible before the silicate matrix of the glass begins to corrode. Consequently, the pKa value of the buffer solution must be below 10, and preferably below 9.5.

### 4. Insoluble Calcium and Magnesium Salts

As part of the neutralisation process, the stain inhibitor reacts with Ca and Mg released from the silicate network of the glass, forming calcium and magnesium based salts. If these salts are insoluble in water, a precipitate remains on the surface of the glass after washing, resulting in a decrease in transmittance and an increase in haze. Hence, A⁻ and X⁻ in the buffer solution chosen must therefore react with alkaline earths to produce water soluble salts.

FIG. 2 is a graph illustrating the pH behaviour of 100 mls of a 0.5M solution in distilled water of the salt of TRIS (tris(hydroxymethyl) aminomethane) with hydrochloric acid in response to the addition of a 1.0M solution of sodium hydroxide. Point “A” marks the ideal initial pH of a buffer system for use as a stain inhibitor on glass, at the point where approximately 3 ml of sodium hydroxide has been added. The region “B”, marked with a dotted line represents the range of pH useful for a stain inhibitor.

In order to determine which neutral buffer systems form suitable stain inhibitors, tests were carried out using the buffers listed in Table 1 below. Table 1 also lists acronyms, chemical names, formulae and initial pKa values. LBK paper (reference) was used in the weathering tests for comparison. Each buffer has been assigned a number to aid in reading the charts in FIGS. 3 and 5:

TABLE 1
Buffers tested for stain inhibitor performance

| Number | Acronym | Chemical Name | Formula | pKa |
|---|---|---|---|---|
| Reference | LBK Paper | — | — | — |
| 1 | TRIS-HCl | Tis (hydroxylmethyl) aminomethane hydrochloride | 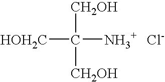 | 8.3 |
| 2 | Borate | Boric Acid/Borax | B(OH)₃ + NaOH = NaB(OH)₄ | 9.2 |
| 3 | TEA-HCl | Triethanolamine hydrochloride | 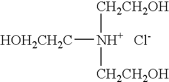 | 7.8 |
| 4 | EPPS | N-2-hydroxycthylpiperazine-N′-3- propane-sulphonic acid | 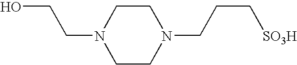 | 8.0 |
| 5 | Tricine | N-[tris (hydroxymethyl) methy] glycine | 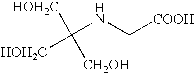 | 8.2 |
| 6 | ADA | N-(2-acetamido)-2-iminodiacetic acid | 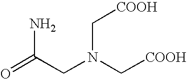 | 6.6 |
| 7 | — | Glycylglycine | 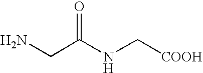 | 8.4 |
| 8 | TRIS Succinate | Tris (hydroxylmethyl) aminomethane succinate | 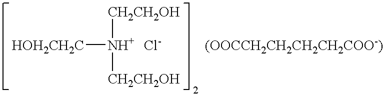 | 8.3 |
| 9 | TAPS | N-[tris(hydroxymethyl)methyl]-3- aminopropanesulphonic acid | 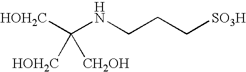 | 8.4 |
| 10 | Phosphate | Sodium dihydrogen phosphate | NaH₂PO₄ + NaOH = Na₂HPO₄ + H₂O | 7.2 |
| 11 | Sulphate | Zinc Sulphate | ZnSO₄ | 7.7 |

Initially, zinc nitrate was chosen for evaluation as a stain inhibitor, but its hygroscopic nature prevented grinding of the powder (available as a hexahydrate) even after drying. Zinc sulphate was used as a substitute.

Samples were prepared from 4 mm thick float glass, cut into 30 cm by 30 cm plates, and washed using a flatbed washer with hot, de-ionised water (at 60° C.), but with no detergent, to remove any glass fragments present on the glass surface from the cutting process. Once washed, the plates of glass were dried using an airknife to avoid drying marks on the surface of the glass. Each stain inhibitor was tested with an interleavant to mimic real life situations where the interleavant is necessary to reduce transit rub and to separate the plates of glass. The individual plates of glass were then stacked in groups of 7, comprising 5 test plates and 2 cover plates, placed on a mini-stillage (i.e. stacked almost vertically on an L-shaped holder) and put into a humidity cabinet for accelerated ageing. The accelerated aging cycle chosen was 40° C./80% relative humidity for 10 days and then 60° C./80% humidity for 40 days. Once ageing was complete, the mini-stillage was removed from the humidity cabinet and each glass plate washed individually to remove the stain inhibitor and the interleavant, and inspected visually for any sign of staining. The haze of each plate was then measured using a BYK-Gardner Haze-gard Plus machine, in accordance with ASTM D 1003.

Table 2 below summarises the quantities of stain inhibitor applied, the type of application and whether solutions were pre-neutralised to neutralise any acid formed during storage of the buffer. PMMA interleavant beads were then applied by hand and the glass submitted to the accelerated weathering test as described above. For application to the surface of the glass, each of the buffers, in powder form, was ground in a Retsch mill to reduce their particle size to 100 μm or less.

TABLE 2
Stain inhibitors as applied to samples

| | Quantity | | | |
|---|---|---|---|---|
| | Applied | | | |
| | (mg Stain | | Pre- | |
| Stain | Inhibitor/m² | Application | Neutral- | |
| Inhibitor | glass) | Solvent/Power | isation | Interleavant |
| TRIS-HCl | 150 mg/m² | Powder blend of | No | PMMA |
| | | NaH₂PO₄ and | | applied with |
| | | PMMA (50:50) | | TRIS-HCl |
| Borate | 200 mg/m² | Solution of boric | No | PMMA |
| | | acid (~0.5M) and | | |
| | | borax (~0.025M) | | |
| | | in methanol | | |
| TEAC-HCl | 380 mg/m² | Warm solution | Yes | PMMA |
| | | (~40° C.) | | |
| | | in DI water | | |
| EPPS | 520 mg/m² | Warm solution | Yes | PMMA |
| | | (~40° C.) | | |
| | | in DI water | | |
| Tricine | 370 mg/m² | Warm solution | Yes | PMMA |
| | | (~40° C.) | | |
| | | in DI water | | |
| ADA | 530 mg/m² | Hot solution | | |
| | | (~50-60° C.) | No | PMMA |
| | | in DI water | | |
| Glycylglycine | 270 mg/m² | Warm solution | Yes | PMMA |
| | | (~40° C.) | | |
| | | in DI water | | |
| TRIS Succinate | 1850 mg/m² | Warm solution | No | PMMA |
| | | (~40° C.) | | |
| | | in DI water | | |
| TAPS | 490 mg/m² | Warm solution | Yes | PMMA |
| | | (~40° C.) | | |
| | | in DI water | | |
| Phosphate | 180 mg/m² | Powder blend of | No | PMMA |
| | | TRIS HCl and | | applied with |
| | | PMMA (50:50) | | NaH₂PO₄ |
| Zinc sulphate | 200 mg/m² | Powder blend of | No | PMMA |
| | | ZnSO₄ and | | applied with |
| | | PMMA (50:50) | | ZnSO₄ |

FIG. 3 is a graph showing haze data for samples treated with the buffers listed in Table 1, each in conjunction with PMMA beads.

The borate buffer performed the best of the buffer systems tested. Only very low haze was observed, with no obvious corrosion patterns. Ideally, the borate buffer comprises a mixture of boric acid and a base, chosen such that the initial pH of the mixture, when dissolved in DI water at concentrations of 0.1M is >6, preferably >7. Suitable bases include borax (sodium borate), as described above, sodium hydroxide and ammonium hydroxide. TAPS, glycylglycine and TRIS succinate also performed well, with ADA and tricine giving good stain inhibitor behaviour in the early stage of the weathering cycle.

The TRIS-HCl buffer performed well, as expected, showing little increase in haze until the end of the weathering cycle. However, although there were no obvious areas of corrosion in the centre of the samples, a “picture frame” band of haze was observed around the edges of each sample. Tests using AFM (atomic force microscopy) and SEM (scanning electron microscopy) indicated the presence of both pitting of the glass surface and deposits of insoluble precipitates. There are two possible explanations for this. Firstly, the material may be hygroscopic, and has “pulled in” moisture from the humid weathering cabinet, leading to corrosion only at the edge of the glass. Secondly, it is possible that the TRIS molecule chelates with silica, reducing the pH at which the matrix dissolves. Citrate anions can promote glass attack, even under neutral conditions, by chelation with silica. However, the TRIS succinate buffer performed much better in weathering tests, leading to the conclusion that the TRIS-HCl buffer material was likely to be hygroscopic.

However, both the phosphate and zinc sulphate buffers performed badly, giving a rapid increase in haze. This was due mainly to insoluble deposits of calcium phosphate and calcium sulphate respectively on the bottom (tin-side) surface of the glass. This illustrates the need for any stain inhibitor to form water soluble calcium and magnesium salts.

Although the measurement of the haze of the glass gives a good indication of the ability of the ester to act as a stain inhibitor, haze is generally perceived subjectively by the human eye. Results from techniques such as AFM are time consuming to obtain, and inconsistent. The early stages of glass corrosion are typified by extremely small etch pits and precipitated deposits, each of the order of tens of nanometres in size. As the major issue with haze is the detrimental effect that the haze has on coatings deposited on stored glass, a more objective test is to coat the stored glass after weathering, once such pits and deposits have appeared on the surface of the glass, and to examine the quality of the coating.

Samples were coated with a multilayer stack as shown in FIG. 4. A weathered glass sample 1 is initially coated with a titania (TiO₂) layer 2. The titania layer is conformal, and so will preserve any surface roughness including etch pits on the weathered glass 1. A zinc oxide (ZnO) layer is then deposited onto the titania layer 2. The zinc oxide layer 3 has a crystalline structure, with the direction of crystal growth being perpendicular to the surface of the titania layer 2, with the [002] crystallographic plane parallel to the surface. A conductive silver (Ag) layer 4 is deposited onto the zinc oxide layer 3. The direction of the crystal growth of the zinc oxide layer 3 will affect the epitaxial deposition of the conductive silver layer 4, which grows with a preferred [111] crystallographic plane parallel to the surface. The zinc oxide layer 3 therefore amplifies the surface topology of the weathered glass surface. Areas of etch pits and precipitates, which increase the roughness of the glass surface, cause the crystallites of the zinc oxide layer 3 and silver layer 4 to become disordered, causing an increase in the sheet resistance of the sample. Hence, the measurement of the resistivity of the coating on the surface of the glass gives an indication of how badly the glass has been stained. A further zinc aluminium oxide layer 5 and a zinc tin oxide (ZnSnOₓ) layer 6 are then deposited on top of the conductive silver layer 4. The sheet resistance of the coated samples was measured using a Nagy SRM-12 sheet resistivity meter.

FIG. 5 is a graph showing sheet resistance data for the samples treated with TRIS-HCl, borate, sodium dihydrogen phosphate, tricine, EPPS and triethanolamine hydrochloride buffers (numbers 1, 2, 10, 5, 4 and 3 in Table 1) each in conjunction with PMMA beads, and with LBK paper, a standard interleavant, for comparison, as described above.

Again, the borate buffer performed well, as would be expected from the results of the haze test, indicating that the buffer is effective in reducing the corrosion of glass due to weathering. Tricine and EPPS also performed well, with triethanolamine hydrochloride also providing an acceptable stain inhibiting performance.

The phosphate and zinc sulphate buffers led to an increase in sheet resistance, although this is less than expected given the poor haze results. This is because most of the hazy deposits on the samples are on the bottom (tin side) surface of the glass, and the sheet resistance test is only concerned with the top surface of the glass.

The above tests illustrate the suitability of certain neutral buffer systems as stain inhibitors for float glass. The buffer compound may comprise an inorganic acid or a non-acidic organic compound. Preferably, the buffer is a mixture of boric acid and a base, having a pH greater than 6. Alternatively, the buffer may be one of: tricine, triethanolamine hydrochloride, TRIS HCl, and TRIS succinate. Table 3 below gives a list of other suitable buffer compounds, their structures and their initial pKa values.

TABLE 3
Other suitable buffer compounds

| Acronym | Chemical Name | Formula | pKa |
|---|---|---|---|
| PIPES | piperazine-N-N′-bis (2- ethanesulphonic acid) | 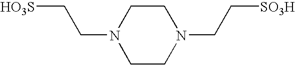 | 6.8 |
| ACES | N-(2-acetamido)-2-aminoethane sulphonic acid | 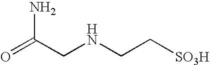 | 6.9 |
| MOPSO | 3-(N-morpholino)-2- hydroxypropanesulphonic acid | 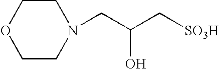 | 6.9 |
| Imidazole- HCl | Imidazole hydrochloride | 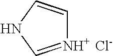 | 7.0 |
| BES | N,N-bis(2-hydroxyethyl)-2- aminoethanesulphonic acid | 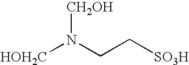 | 7.1 |
| MOPS | 3-(N-morpholino) propanesulphonic acid | 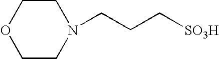 | 7.2 |
| TES | 2-[tris (hydroxymethyl) methyl] amino ethanesulphonic acid | 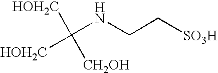 | 7.5 |
| HEPES | N-2-hydroxyethylpiperazine-N′- 2-ethane-sulphonic acid | 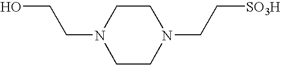 | 7.6 |
| TAPSO | N-[tris(hydroxymethyl)methyl]- 3-amino-2- hydroxypropanesulphonic acid | 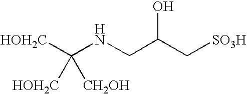 | 7.6 |
| POPSO | piperazine-N-N′-bis (2- hydroxypropanesulphonic acid) | 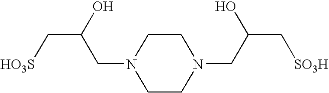 | 7.8 |
| EPPS | N-2-hydroxycthylpiperazine-N′- 3-propane-sulphonic acid | 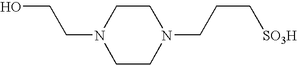 | 8.0 |
| TRIS- acetate | tris (hydroxylmethyl) aminomethane acetate | 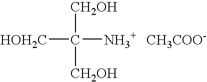 | 8.3 |
| Bicine | N,N-bis(2-hydroxyethyl) glycine | 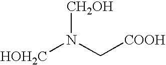 | 8.4 |
| CHES | 2-(cyclohexylamino) ethanesulphonic acid | 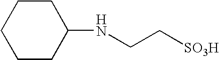 | 9.5 |

1. A stain inhibitor, which acts to neutralise alkali leached to the surface of a sheet of glass in the presence of water, comprising a buffer compound, which, before application to the glass, has a pKa value of between 6.0 and 10.0.

2. The stain inhibitor of claim 1, wherein the pKa value is between 7.0 and 9.5.

3. The stain inhibitor of claim 1, where in the pKa value is between 7.0 and 9.0.

4. The stain inhibitor of claim 1, wherein the pH value of the buffer compound, when dissolved in DI water, is greater than 6.0.

5. The stain inhibitor of claim 1, wherein the pH value of the buffer compound, when dissolved in DI water, is greater than 7.0.

6. The stain inhibitor of claim 1, wherein the buffer compound has an anion which forms salts of calcium and magnesium that are soluble in water.

7. The stain inhibitor of claim 1, wherein the buffer compound comprises a non-acidic organic compound or an inorganic acid.

8. The stain inhibitor of claim 1, wherein the buffer compound comprises a non-acidic organic compound.

9. The stain inhibitor of claim 8, wherein the buffered compound is one of tricine, triethanolamine hydrochloride, TRIS HCl, and TRIS succinate.

10. The stain inhibitor of claim 1, wherein the buffer compound comprises an inorganic acid.

11. The stain inhibitor of claim 1, wherein the buffer compound comprises a mixture of boric acid and a base, such that the initial pH of the mixture is greater than 6.

12. The stain inhibitor of claim 11, wherein the base is one of sodium borate, sodium hydroxide or ammonium hydroxide.

13. The stain inhibitor of claim 1, wherein the buffer compound is applied to the surface of the glass as a powder.

14. The stain inhibitor of claim 13, wherein the powder is first mixed with an interleavant, and then applied to the surface of the glass.

15. The stain inhibitor of claim 1, wherein the buffer compound is applied to the surface of the glass in solution with a solvent.

16. The stain inhibitor of claim 15, wherein the solvent is methanol.

17. The stain inhibitor of claim 1, wherein an interleavant is also applied to the surface of the glass.

18. The stain inhibitor of claim 17, wherein the interleavant is one of PMMA beads, UHMWPE beads, coconut husk flour, hard wood flour or paper.

19. A method of reducing the haze of the surface of a sheet of glass in storage, comprising applying a stain inhibitor to the surface of the glass, the stain inhibitor comprising a buffered compound, which, before application to the surface of the glass, has a pKa value between 6.0 and 10.

20. Glass treated with the stain inhibitor of claim 1.

21. (canceled)

22. (canceled)

23. A method of preventing the corrosion of glass in storage utilizing a buffer compound as a stain inhibitor.
